(19) United States
(12) Patent Application Publication
(10) Pub. No.: US 2019/0055906 A1
(43) Pub. Date: Feb. 21, 2019

(54) COOLER FOR VEHICLE

(71) Applicants: Hyundai Motor Company, Seoul (KR); Kia Motors Corporation, Seoul (KR)

(72) Inventors: Dong Young LEE, Goyang-si (KR); Seok HA, Seoul (KR); Sung II YOON, Seoul (KR); Tae Ho JEONG, Yongin-si (KR)

(73) Assignees: Hyundai Motor Company, Seoul (KR); Kia Motors Corporation, Seoul (KR)

(21) Appl. No.: 15/833,251

(22) Filed: Dec. 6, 2017

(30) Foreign Application Priority Data
Aug. 18, 2017 (KR) 10-2017-0104639

(51) Int. Cl. F02M 26/29

(52) U.S. Cl. CPC F02M 26/29

(57) ABSTRACT

A cooler apparatus for a vehicle may include the tube formed in the clad metal configured such that inosculation layers are formed at both external surfaces of diffusion preventing layers which are A1000 series in a state of forming the diffusion preventing layers at both surfaces of a lead layer including aluminum alloy.

### CROSS-REFERENCE TO RELATED APPLICATION

The present application claims priority to Korean Patent Application No. 10-2017-0104639 filed on Aug. 18, 2017, the entire contents of which is incorporated herein for all purposes by this reference.

### BACKGROUND OF THE INVENTION

### Field of the Invention

The present invention relates to a cooler for a vehicle. More particularly, the present invention relates to a cooler for a vehicle configured for improving durability and corrosion resistance as a material forming a tube is to be better.

### Description of Related Art

Recently, regulations on exhaust gas have been strengthened due to environmental problems such as global warming.

Particularly, stringent regulations on an amount of exhaust gas of a vehicle are being applied.

Therefore, technologies for reducing harmful substance of exhaust gas of a vehicle are provided. One of such technologies is an exhaust gas recirculation (EGR) system.

Such an EGR system circulates a portion of an exhaust gas which is discharged from an engine as an intake gas to function to reduce an oxygen amount within a mixer, to reduce an exhaust amount of an exhaust gas, and to reduce an amount of harmful material within the exhaust gas. Furthermore, the EGR system may include a cooler for cooling exhaust gas.

A coolant passage through which coolant is passed and a tube through which exhaust gas is passed are provided to the cooler such that the cooler performs heat exchange between exhaust gas and coolant.

However, in case that temperature of exhaust gas is decreased in the tube by engine off and so on, a part of exhaust gas is to be corrosive condensate. Thus, the tube may be corroded by corrosive condensate, and a leak of exhaust gas may be occurred.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a cooler for a vehicle having advantages of improving brazing performance and durability.

A cooler for a vehicle according to an exemplary embodiment of the present invention may be configured so that a tube forming an exhaust gas passage is mounted in a cooler housing forming a coolant passage and a cooling pin is inosculated in the tube with a set pattern such that the exhaust gas passage is partitioned. The cooler may include the tube formed in the clad metal configured such that inosculation layers are formed at both external surfaces of diffusion preventing layers which are A1000 series in a state of forming the diffusion preventing layers at both surfaces of a lead layer including aluminum alloy.

The tubes may be disposed apart from each other as a set gap with respect to a vertical direction in the cooler housing and may be inosculated to the cooler housing on the present state.

A lead layer may include aluminum alloy including manganese.

The lead layer may include an A3000 series material.

The inosculation layer may include an A4000 series material for brazing inosculating the tube with the cooling pin.

A thickness of the inosculation layer and a thickness of the diffusion preventing layer may be predetermined in 5-10% ranges of an entire thickness of the clad metal.

The cooling pin may include an A3000 series material.

The cooling pin may be inosculated with the tube through the inosculation layer in a state of being interposed in the tube with a protrusions and depressions shape.

Furthermore, effects that can be obtained or expected from exemplary embodiments of the present invention are directly or suggestively described in the following detailed description. That is, various effects expected from exemplary embodiments of the present invention will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a cooler for a vehicle according to an exemplary embodiment of the present invention.

FIG. 2 is a cross-sectional view taken along line A-A of FIG. 1.

FIG. 3 is a drawing representing materials of a tube applied to a cooler for a vehicle according to an exemplary embodiment of the present invention.

FIG. 4 is an experiment photograph representing diffusing factor of manganese after performing Sea Water Acetic Acid Test (SWAAT) to a tube applied to a cooler for a vehicle according to an exemplary embodiment of the present invention and a tube applied to a cooler for a vehicle according to a relative embodiment.

FIG. 5 is an experiment graph comparing thickness of a tube applied to a cooler for a vehicle according to an exemplary embodiment of the present invention with thickness of a tube applied to a cooler for a vehicle according to a relative embodiment as time passed.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The drawings and description are to be regarded as illustrative in nature and not restrictive, and like reference numerals designate like elements throughout the specification.

In the following description, dividing names of components into first, second and the like is to divide the names because the names of the components are the same as each other and an order thereof is not particularly limited.

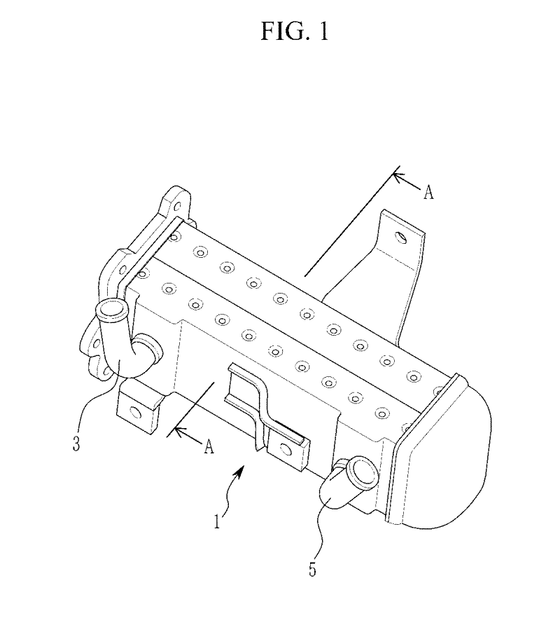

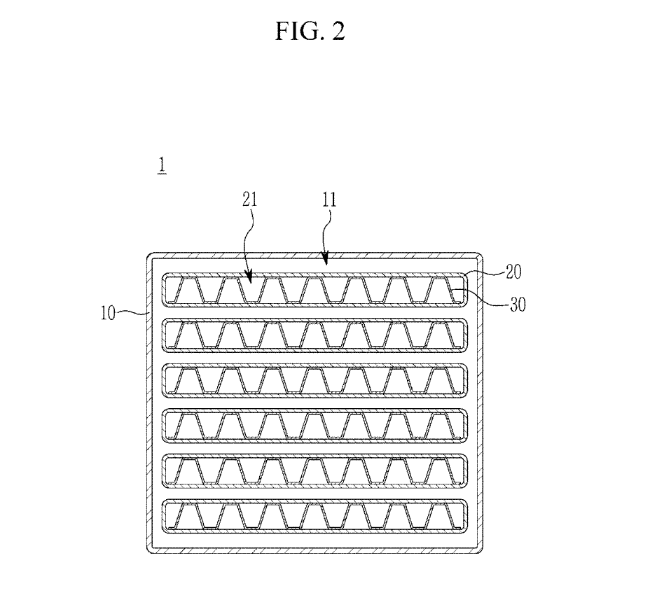

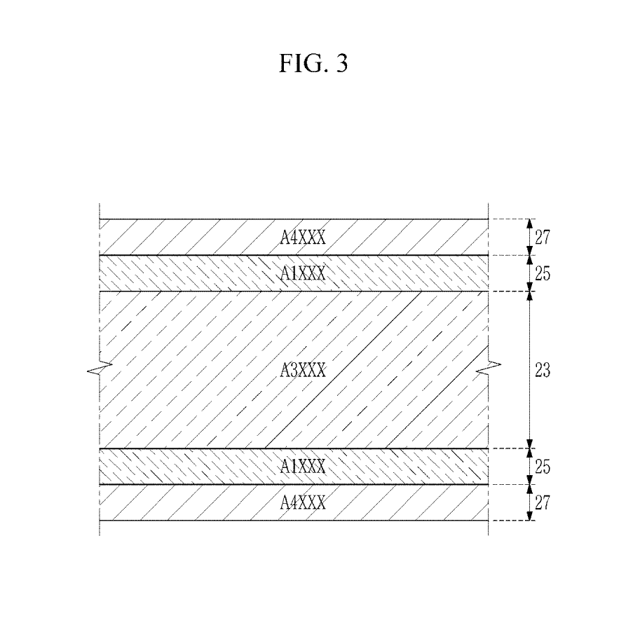

FIG. 1 is a perspective view of a cooler for a vehicle according to an exemplary embodiment of the present invention, and FIG. 2 is a cross-sectional view taken along line A-A of FIG. 1, and FIG. 3 is a drawing representing materials of a tube applied to a cooler for a vehicle according to an exemplary embodiment of the present invention.

Referring to FIG. 1, a cooler 1 for a vehicle according to an exemplary embodiment of the present invention is configured to cool exhaust gas which is re-circulated from an exhaust line of an engine system to an intake line.

That is, the cooler 1 cools exhaust gas being re-circulated by use of coolant, and for the present purpose. An intake pipe 3 flowing coolant thereinto and an exhaust pipe 5 exhausting coolant therethrough are connected to the cooler 1.

Furthermore, a structure of the cooler 1 according to an exemplary embodiment of the present invention may be applied to various heat exchangers.

Referring to FIG. 2, the cooler 1 includes a cooler housing 10, tubes 20, and cooling pins 30.

Firstly, the cooler housing 10 is configured to form a coolant passage 11 therein, and so that coolant is flowed in and exhausted through the intake pipe 3 and the exhaust pipe 5 which are connected to one side thereof and the other side thereof.

The tubes 20 are disposed apart from each other as a set gap with respect to a vertical direction in the cooler housing 10 and are inosculated to the cooler housing 10 on the present state.

The tubes 20 respectively form an exhaust gas passage 21.

Referring to FIG. 3, the tube 20 includes a clad metal including five layers.

In other words, the tube 20 is formed in the clad metal including a lead layer 23 including aluminum alloy including manganese to be positioned at the center, diffusion preventing layers 25 inosculated on both surfaces of the lead layer 23, and inosculation layers 27 inosculated on both external surfaces of the diffusion preventing layers 25.

In this regard, the lead layer 23 formed in an aluminum-high manganese alloy material which includes a large amount of manganese.

As the aluminum-high manganese alloy material is applied to the lead layer 23, stiffness and corrosion resistance of the lead layer 23 are configured to be improved.

For instance, the lead layer 23 includes a material including A3000 series (Al—Mn series).

Furthermore, the tube 20 is configured so that the diffusion preventing layers 25 are formed at both surfaces of the lead layer 23.

It is desirable that a thickness of the diffusion preventing layer 25 is predetermined in 5-10% range of an entire thickness of the clad metal.

The diffusion preventing layer 25 includes a material including A1000 series (pure A1 series).

Furthermore, the tube 20 is configured so that the inosculation layers 27 are formed at both external surfaces of the diffusion preventing layers 25.

The inosculation layer 27 includes a filler material for brazing inosculating with a cooling pin 30.

Herein, the brazing inosculation is an inosculation method to do not melt a basic material and only melt a filler metal by use of the filler metal having a low melting point temperature in comparison with the basic material being inosculated.

Furthermore, it is desirable that a thickness of the inosculation layer 27 is predetermined in 5-10% ranges of an entire thickness of the clad metal to be like with the diffusion preventing layer 25.

The inosculation layer 27 includes a material including A4000 series (Al—Si series).

Meanwhile, the cooling pin 30 partitions the exhaust gas passage 21 in the tube 20.

The cooling pin 30 is formed in a protrusions and depressions shape and is brazing-inosculated with the tube 20 in a state of interposing in the tube 20.

In this regard, the cooling pin 30 is brazing-inosculated by use of the inosculation layer 27, which is disposed at both surfaces of the tube 20, as a filler metal.

The cooling pin 30 includes a material being included to A3000 series (Al—Mn series).

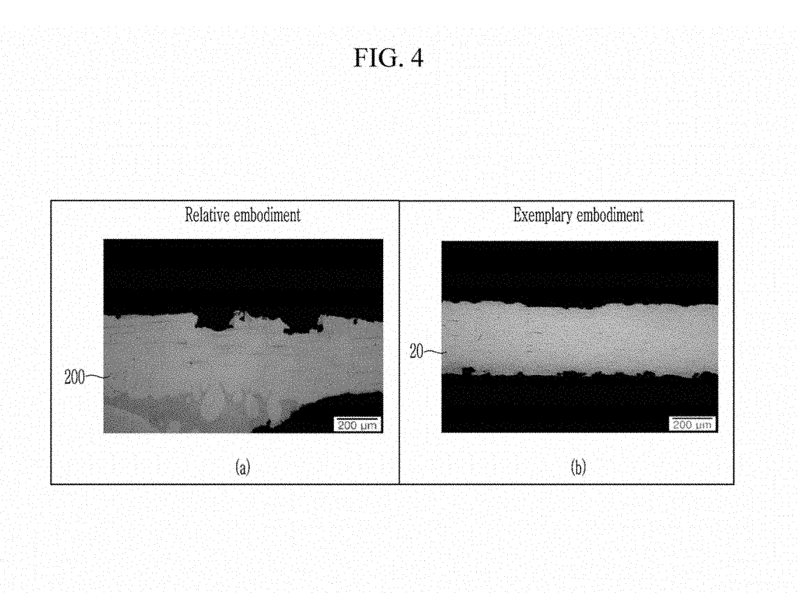

FIG. 4(a) is an experiment photograph representing diffusing factor of manganese after performing SWAAT to a tube 200 applied to a cooler for a vehicle according to a relative embodiment, and FIG. 4(b) is an experiment photograph representing diffusing factor of manganese after performing SWAAT to the tube 20 applied to the cooler 1 for a vehicle according to an exemplary embodiment of the present invention.

The SWAAT is a method exposing a test piece during a predetermined time on a predetermined pH and a predetermined temperature after adding acetic acid to artificial sea water.

The SWAAT condition will be referred to as follows.

TABLE 1

| | |
|---|---|
| Solution | Sea water |
| Salt concentration | 42 g/L |
| Acetic acid | 10 ml/L |
| pH | 2.8-3.0 |
| Temperature | 49° C. |

In this regard, the tube 200 applied to a cooler for a vehicle according to a relative embodiment forms diffusion preventing layers, which is A3003, at both surfaces with respect to a lead layer, which is A3000 series, and forms a inosculation layers, which is A4000 series, both external surfaces of the diffusion preventing layers.

Examining cross-sections of the respective tubes after ten weeks passing on the above mentioned experiment conditions, the tube 200 of FIG. 4(a) according to a relative embodiment is corroded in many portions, while, the tube 20 of FIG. 4(b) according to an exemplary embodiment is corroded in very little portions.

In other words, the tube 20 applied to the cooler 1 for a vehicle according to an exemplary embodiment of the present invention is configured for improving corrosion resistance by the diffusion preventing layer 25 which is A1000 series.

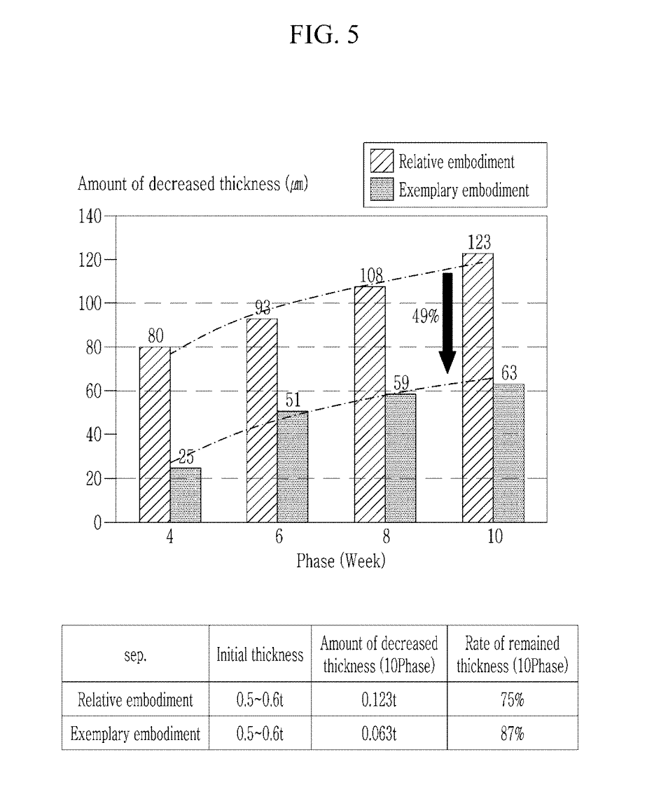

FIG. 5 is an experiment graph comparing thickness of a tube applied to a cooler for a vehicle according to an exemplary embodiment of the present invention with thickness of a tube applied to a cooler for a vehicle according to a relative embodiment as time passed.

That is, FIG. 5 represents an experiment about change of thickness by corrosion of the tubes according to an exemplary embodiment and a relative embodiment.

Referring to FIG. 5, an initial thickness of the tube 20 according to an exemplary embodiment of the present invention and an initial thickness of a tube according to a relative embodiment are predetermined in 0.5t to 0.6t range.

The thickness of the tube 20 according to an exemplary embodiment of the present invention is to be decreased as 0.025t when four weeks passing, as 0.051t when six weeks passing, as 0.059t when eight weeks passing, and as 0.063t when ten weeks passing.

Meanwhile, the thickness of the tube 200 according to a relative embodiment is to be decreased as 0.080t when four weeks passing, as 0.093t when six weeks passing, as 0.108t when eight weeks passing, and as 0.123t when ten weeks passing.

At the present time, the amount of the remained thickness when ten weeks passing in the tube 20 according to an exemplary embodiment of the present invention and the tube 200 according to a relative embodiment are respectively 87% and 75%.

In other words, the amount of the decreased thickness of the tube 20 according to an exemplary embodiment of the present invention is small as 49% in comparison with the amount of the decreased thickness of the tube 200 according to an exemplary embodiment.

According to an exemplary embodiment of the present invention, improving brazing performance and durability can be improved as it is prevented by the diffusion preventing layer 25 which is A1000 series that manganese is diffused when the cooling pin 30 which is inserted into the tube 20 is brazing-inosculated with the tube 20.

Therefore, basic durability of the lead layer 23 may be maintained.

Furthermore, corrosion resistance can be improved in the cooler 1 for a vehicle according to an exemplary embodiment of the present invention as corrosion of the tube 20 is suppressed by the diffusion preventing layer 25 which is A1000 series.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

1. A cooler apparatus for a vehicle, which is configured so that a tube forming an exhaust gas passage is mounted in a cooler housing forming a coolant passage and a cooling fin is inosculated in the tube with a predetermined pattern such that the exhaust gas passage is partitioned, comprising:
the tube formed in a clad metal configured such that brazing layers are formed at first and second external surfaces of diffusion preventing layers which are A1000 series in a state of forming the diffusion preventing layers at first and second surfaces of a main layer including aluminum alloy,
wherein the tubes are disposed apart from each other as a predetermined gap with respect to a vertical direction in the cooler housing and are inosculated to the cooler housing,
wherein the main layer includes aluminum alloy including manganese,
wherein the main layer includes an A3000 series material,
wherein the brazing layers include an A4000 series material for brazing inosculating the tube with the cooling fin, and
wherein a thickness of the brazing layers and a thickness of the diffusion preventing layers are predetermined in 5-10% ranges of an entire thickness of the clad metal.

2-6. (canceled)

7. The cooler apparatus of claim 1, wherein the cooling fin includes an A3000 series material.

8. The cooler apparatus of claim 1, wherein the cooling fin is inosculated with the tube through the brazing layers in a state of being interposed in the tube with a protrusion and depression shape.
